(19) United States
(12) Patent Application Publication
(10) Pub. No.: US 2008/0228880 A1
(43) Pub. Date: Sep. 18, 2008

(54) MANAGED CODE MAPI APIS

(75) Inventors: Sundar Naresh, Redmond, WA (US); Joseph R. Warren, Renton, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/684,877

(22) Filed: Mar. 12, 2007

(51) Int. Cl. G06F 15/16

(52) U.S. Cl. 709/206

(57) ABSTRACT

An API called MAPI.NET written in managed code allows front-end applications written in managed code to access backend data stores using existing MAPI technology. Functions within this API provide ways in which data from a mailbox or a public folder on a backend server is accessed.

### BACKGROUND

As business becomes more competitive, the success of an organization increasingly depends on how quickly, smoothly, and efficiently people within that organization work together. The key to a successful organization is how well that organization manages and distributes information. Networking is an important part of teamwork because it enables fast and efficient information exchange. Organizations must also keep track of the information and manage its distribution. Electronic messaging systems provide these capabilities.

Electronic messaging has become critically important to enterprise computing. In fact, many organizations expect their electronic messaging systems to take on the role of a central communications backbone, used not only for electronic-mail (e-mail or email) messages, but to integrate all types of information. Electronic messaging provides a way for users in organizations to retrieve information from a variety of sources, to exchange information automatically, and to store, filter, and organize the information locally or across a network.

Today, powerful enterprise-wide workgroup applications that manage group scheduling, forms routing, order processing, and project management are built on electronic messaging systems. Hundreds of different messaging systems are offered by different vendors, (including (including Microsoft® Exchange, IBM® Lotus Notes®, IBM® Domino®, Novell® Groupwise®, SAP® R/3® Enterprise Software, Oracle® Interoffice™, Oracle® Collaboration Suite (OCS) and others) and a wide range of applications have been built to use them. But each of these messaging systems has a different programming interface, making an extensive development effort necessary to enable an application to interact with more than one system.

To solve this problem, Messaging Application Programming Interface (MAPI) was created. MAPI is a messaging architecture that enables multiple applications to interact with multiple messaging systems seamlessly across a variety of hardware platforms. MAPI is made up of a set of common application programming interfaces (APIs) and a dynamic-link library and is written in native code. The native code MAPI APIs can be used in programs to create and access diverse messaging applications and messaging systems, offering a uniform environment for development and use without requiring the knowledge of underlying specific messaging systems. The DLL contains the MAPI subsystem, which manages the interaction between front-end messaging applications and back-end messaging systems and provides a common user interface for frequent tasks. The MAPI subsystem acts as a central clearinghouse to unify the various messaging systems, making differences between messaging systems transparent to the client users. The MAPI architecture typically operates across a network and includes two sets of APIs, one set for clients and one set for service providers.

### SUMMARY

Middle-tier to backend, data access APIs referred to collectively as MAPI.NET, written in managed code, allow applications to access data stored in mailboxes and public folders using the existing MAPI architecture. For example, A MAPI client such as Microsoft® Outlook® 2007 running on a client node may connect to a backend MAPI server using the MAPI.NET API. Similarly, a middle-tier service provider such as Microsoft® Outlook® Web Access Server running on a middle-tier server node may connect to a backend MAPI server using the MAPI.NET API. The APIs include methods that specify a server to open a mailbox for reading or writing of messages in the server, automatically redirecting the call to a correct server if the mailbox being opened is on a different server; methods that specify a server to open a mailbox for reading or writing of messages in the server, returning the correct server but not the opened mailbox, if the mailbox being opened is on a different server; methods that specify a server to open a public folder, automatically redirecting the call to a correct server if the public folder being opened is on a different server; methods that specify a server to open a public folder, returning the correct server but not the opened public folder, if the public folder being opened is on a different server; methods that open a Table of Contents of items in a specified folder and methods to open a single item or folder inside of a specified mailbox or public folder. These methods are written in managed code to integrate with front-end applications written in managed code to access the specified backend data.

### BRIEF DESCRIPTION OF THE DRAWINGS

In the drawings:

FIG. 1a is a block diagram representing an exemplary network environment in accordance with embodiments of the invention;

FIG. 1b is a block diagram illustrating an exemplary computing environment in which aspects of the invention may be implemented;

FIG. 2 is a block diagram of a system for accessing backend server data stores in accordance with some embodiments of the invention; and

FIG. 3 is a flow diagram of a method for accessing backend server data stores in accordance with some embodiments of the invention; and

FIG. 4 is another flow diagram of a method for accessing backend server data stores in accordance with some embodiments of the invention.

### DETAILED DESCRIPTION

### Overview

MAPI was originally built into the Microsoft® Windows® family of operating systems and was a component of Microsoft® Windows® 95 and Microsoft Windows NT® operating systems. MAPI was also used by certain Microsoft® Office applications and in particular by the Microsoft® Outlook® email client, to access electronic mail on a Microsoft® Exchange electronic mail server It provides a uniform way to access email or messages and is a published architecture.

The Microsoft® .NET Framework is a software component written in managed code that provides a number of pre-coded solutions to common program requirements, and manages the execution of programs written for the framework, (hence the term “managed code”). Because interaction between new and older applications is commonly required, the .NET Framework provides means to access functionality that is implemented in code that is outside the .NET environment. The pre-coded solutions in the namespaces form the framework's class library and cover a large range of programming needs including data access and network communications.

Programs written for the .NET Framework execute in a software environment that manages the program's runtime requirements. This runtime environment, part of the .NET Framework, is known as the Common Language Runtime (CLR). The CLR provides the appearance of an application virtual machine, so that capabilities of the specific CPU that will execute the program do not need to be addressed. Programming languages on the .NET Framework compile into an intermediate language known as the Common Intermediate Language, or CIL. One implementation of CIL is known as the Microsoft® Intermediate Language, or MSIL. MSIL may be compiled into native code in a manner known as just-in-time compilation (JIT) instead of being interpreted. Because the .NET Framework supports a Common Type System, or CTS that defines all possible datatypes and programming constructs supported by the CLR and how they may or may not interact with each other, the .NET Framework supports development in multiple programming languages.

As described herein, an API called MAPI.NET written in managed code allows front-end applications written in managed code to access backend data stores using existing MAPI technology. Functions within this API are described herein and provide ways in which data from a mailbox or a public folder on a backend server is accessed.

### Exemplary Computing Environment

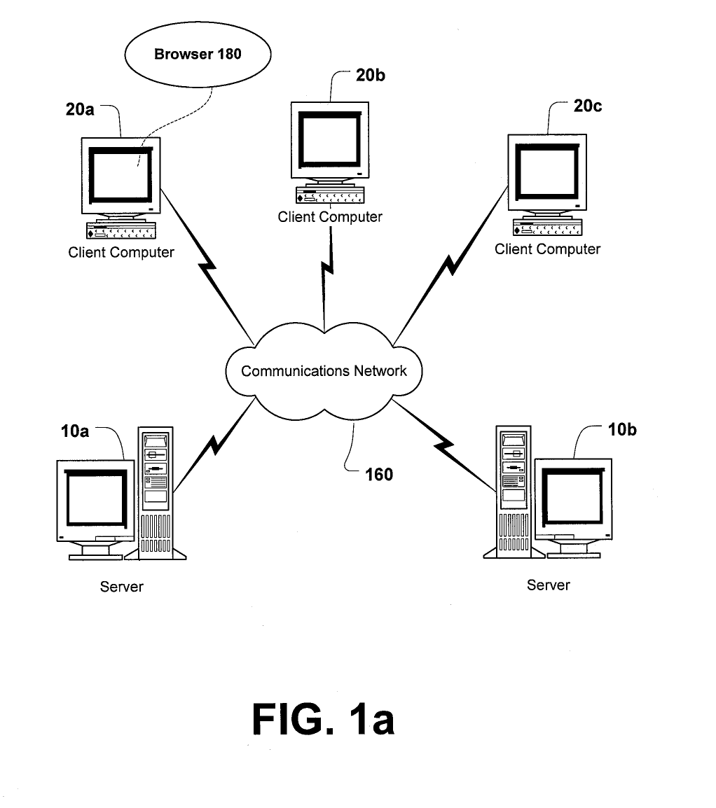

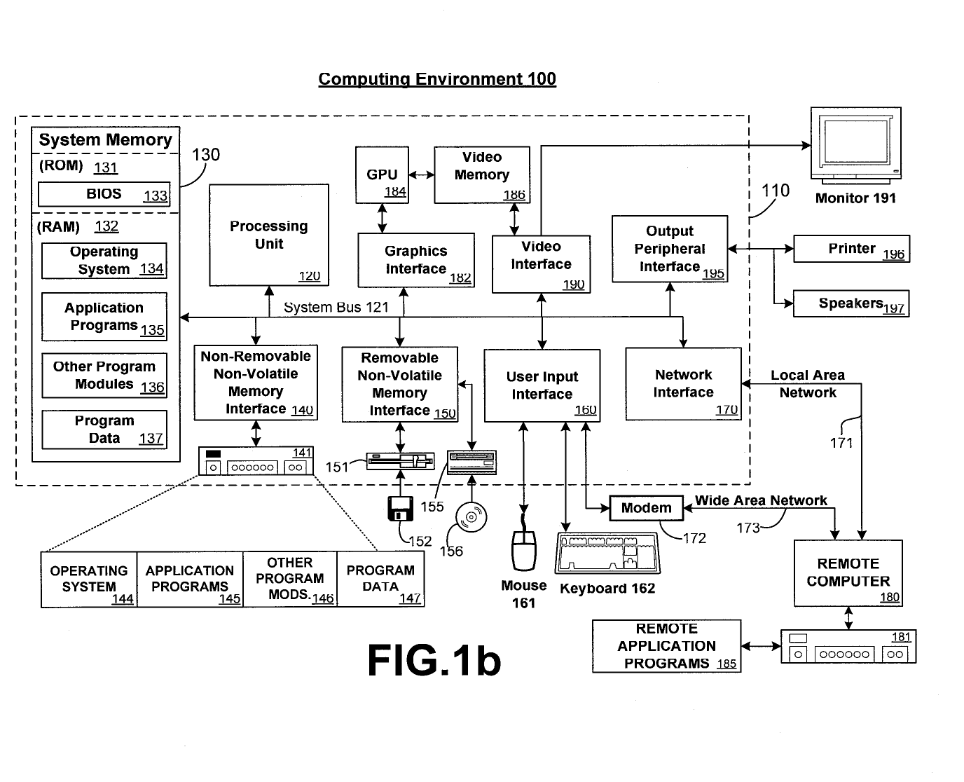

Embodiments of the invention may be deployed as part of a computer network. In general, the computer network may comprise both server computers and client computers deployed in a network environment. FIG. 1a illustrates an exemplary network environment, with a server in communication with client computers via a network, in which embodiments of the invention may be employed. As shown in FIG. 1a, a number of servers 10a, 10b, etc., are interconnected via a communications network 160 (which may be a LAN, WAN, intranet or the Internet, telephony or VoIP network) with a number of client computers 20a, 20b, 20c, etc. In a network environment in which the communications network 160 is the Internet, for example, the servers 10 can be Web servers with which the clients 20 communicate via any of a number of known protocols such as hypertext transfer protocol (HTTP). Each client computer 20 can be equipped with a browser 180 to gain access to the servers 10. In addition to using the network 160 in a client-server configuration, client computer 20a, 20b, 20c may communicate directly with each other in a peer-to-peer configuration.

Embodiments of the invention may be deployed in a network environment, where that network is an Internet or Intranet environment. The term “Internet” is an abbreviation for “Internetwork,” and refers commonly to the collection of networks and gateways that utilize the TCP/IP suite of protocols, which are well-known in the art of computer networking. TCP/IP is an acronym for “Transport Control Protocol/Internet Protocol.” The Internet can be described as a system of geographically distributed remote computer networks interconnected by computers executing networking protocols that allow users to interact and share information over the networks. Because of such wide-spread information sharing, remote networks such as the Internet have thus far generally evolved into an open system for which developers can design software applications for performing specialized operations or services, essentially without restriction.

Electronic information transmitted by one of the common protocols (e.g., TCP/IP, UDP, etc.) is generally broken into packets. The packets are addressed to one of the other computers 20a, 20b, 20c, 10a, 10b connected to network 160. The addressed computer receives the packets, strips out the informational content of the packets, and reassembles the transmitted electronic information. The electronic information may be audio, video, text, mixed media and so on.

A transmission of data can be sent by a client application program to a server or to another client, depending on the system configuration. If the data is transmitted to a server, the server may transmit this data to another client application program. The client process may be active in a first computer system, and the server process may be active in a second computer system, communicating with one another over a communications medium, thus providing distributed functionality and allowing multiple clients to take advantage of the capabilities of the server.

Thus, embodiments of the invention can be utilized in a computer network environment having client computers for accessing and interacting with the network and a server computer for interacting with client computers. However, the systems and methods in accordance with embodiments of the invention can be implemented with a variety of network-based architectures, and thus should not be limited to the example shown. Embodiments of the invention can also be utilized in stand-alone computer systems unconnected to a network, in embedded systems, and in any other sort of computer system where accessing backend data is helpful.

FIG. 1b and the following discussion are intended to provide a brief general description of a suitable computing environment in which the invention may be implemented. It should be understood, however, that handheld, portable, and other computing devices of all kinds are contemplated for use in connection with embodiments of the invention. While a general purpose computer is described below, this is but one example, and only a thin client having network server interoperability and interaction may be required. Thus, embodiments of the invention may be implemented in an environment of networked hosted services in which very little or minimal client resources are implicated, e.g., in a networked environment in which the client device serves merely as a browser or interface to the World Wide Web.

Embodiments of the invention can be implemented via an application programming interface (API), for use by a developer, and/or included within the network browsing software which will be described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. The invention may also be practiced in distributed computing environments where tasks are performed by remote processing devices that are linked through a communications network or other data transmission medium. In a distributed computing environment, program modules may be located in both local and remote computer storage media including memory storage devices.

FIG. 1b thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 1b, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1b illustrates operating system 134, application programs 135, other program modules 136, and program data 137.

The computer 110 may also include other removable/non-removable, volatile/nonvolatile computer storage media. By way of example only, FIG. 1b illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1b provide storage of computer readable instructions, data structures, program modules and other data for the computer 110. In FIG. 1b, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. A graphics interface 182, such as Northbridge, may also be connected to the system bus 121. Northbridge is a chipset that communicates with the CPU, or host processing unit 120, and assumes responsibility for accelerated graphics port (AGP) communications. One or more graphics processing units (GPUs) 184 may communicate with graphics interface 182. In this regard, GPUs 184 generally include on-chip memory storage, such as register storage and GPUs 184 communicate with a video memory 186. GPUs 184, however, are but one example of a coprocessor and thus a variety of coprocessing devices may be included in computer 110. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1b include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1b illustrates remote application programs 185 as residing on memory device 181. It will be appreciated that the network connections shown are exemplary and other means of establishing a communications link between the computers may be used.

One of ordinary skill in the art can appreciate that a computer 110 or other client device can be deployed as part of a computer network. In this regard, embodiments of the invention pertains to any computer system having any number of memory or storage units, and any number of applications and processes occurring across any number of storage units or volumes. Embodiments of the invention may apply to an environment with server computers and client computers deployed in a network environment, having remote or local storage. Embodiments of the invention may also apply to a standalone computing device, having programming language functionality, interpretation and execution capabilities.

### Managed Code MAPI APIs

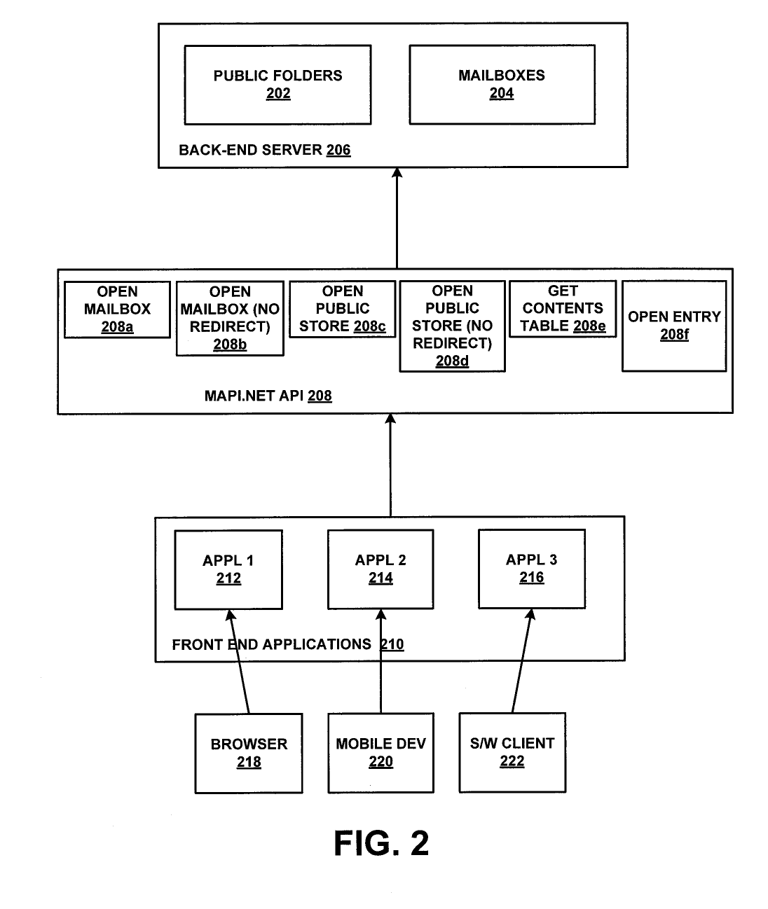

FIG. 2 illustrates an example of one possible system for using managed code APIs to access backend data stores using the MAPI protocol. The system may reside on one or more computers such as the one illustrated above with respect to FIGS. 1a and 1b. The computers in the system may be connected via computer and/or telephony networks as described above. The system may include one of more of the following: front end applications/access layer 210 which access a set of functions of an API 208 (called herein the MAPI.NET API) written in managed code that issues RPC calls to a backend server 206 to access data stores (e.g., public folders 202 and mailboxes 204) residing on the backend server 206. The system may also include the backend server 206 itself and its data stores 202 and 204. The backend server 206 may have functions that are exposed through a remote procedure call component that enables clients to make remote procedure calls to the server 206. A remote procedure call allows a call to be made from one computer to another computer where the calling computer requests the called computer to perform some action or execute some operation for the calling computer. In some embodiments of the invention, the data stores 202 and 204 combine voice messaging, fax and email messaging into a unified data store accessible from a telephone and/or a computer.

In accordance with embodiments of the invention, a client access layer 210 may support a number of front end applications such as application 1 212, application 2 214 and application 3 216, etc. These applications may represent applications that enable a browser 218 to access back-end data stores (e.g., Microsoft® Outlook® Web Access), applications that enable a mobile device 220 to access back-end data stores (e.g., Microsoft® Exchange ActiveSync®), applications that enable a software client 222 to access back-end data stores (e.g., Microsoft® Outlook® Express, Eudora®, etc.) and email applications such as Microsoft® Office Outlook® to access back-end data stores. These applications may use a number of protocols including Post Office Protocol version 3 (POP3), Internet Message Access Protocol version 4 rev 1 (IMAP4), HTTP, TCP/IP and so on.

The client access layer 210 may receive a request from a client such as any of clients 218, 220, 222, etc. that in order to be fulfilled requires that a backend data store be accessed. If so, the client access server gets the information required from the client request, determines the appropriate MAPI.NET function to call and translates the request into the appropriate corresponding MAPI.NET call. The MAPI.NET call in some embodiments of the invention is translated to a native code RPC call. The translated call is sent to the backend server 206. The backend server 206 responds by either performing the operation on the data store, returning information concerning the location of the data store or by denying access. The backend server 206 may host the requested mailbox 204 or public folder 202 databases or may not. If the backend server 206 does not host the requested data store, an operation request may be redirected automatically to the server that hosts the requested data store or alternatively, the identity of the server who does host the data store may be returned.

Suppose, for example, a request comes in from a client (for example from a browser or smart-phone) to a front-end application. Suppose that, to satisfy the request, a mailbox specified in the request must be opened. Suppose the specified mailbox is hosted on a backend server (e.g., server 206). The MAPI.NET API includes several types of functions that open a mailbox. Hence, the front-end application that received the request to open the specified mailbox determines the appropriate MAPI.NET function to be called (one of the open mailbox functions), determines what input parameters the appropriate MAPI.NET function (method) requires, gleans this information from the initial request and satisfies the API by sending the appropriate information so that the selected function can open the mailbox. The open mailbox function call in some embodiments of the invention is translated to an RPC call using the MAPI protocol. The backend server receives the open mailbox RPC call. The backend server processes the request according to the received parameters, and may return the requested information from the backend server to the client access layer for forwarding to the client. The backend server may authenticate to make sure the entity making the request is supposed to have access to that mailbox and either deny access because the entity making the request is not supposed to have access to that mailbox or respond with the necessary tokens to provide access to the mailbox. The client access layer may then send the requested information to the initial requester, using the appropriate protocol for the initial requestor.

The MAPI.NET API includes the following methods: MapiStore.OpenMailbox, 208a, MapiStore.OpenMailboxNoRedirect, 208b, MapiStore.OpenPublicStore, 208c, MapiStore.OpenPublicStoreNoRedirect, 208d, MapiContainer.GetContentsTable, 208e, and MapiContainer.OpenEntry 208f. It will be appreciated that the names of the functions and parameters are only example names and do not limit the contemplated invention to these or any other particular names. In object-oriented programming, the term method refers to a piece of code that is exclusively associated either with a class (called a class method or static method) or with an object (called an instance method). A method usually includes a sequence of statements to perform an action, a set of input parameters to customize those actions, and possibly an output value (called a return value) of some kind. The purpose of a method is to provide a mechanism for accessing (for reading, writing or reading and writing) the private data stored in an object or a class.

The OpenMailbox method 208a in some embodiments of the invention is associated with the class, MapiStore:MapiProp and is used to open a mailbox for subsequent reading or writing of messages in the opened mailbox. If the mailbox being opened is on a different server than the one receiving the method call, this method automatically re-directs the call to the correct server. One or more of the following 15 overloaded method signatures may be used to operate on the mailbox on the backend server 206. Each of these signatures correspond with a set of input parameters comprising some combination of the following pieces of information:

serverDn refers to the name (data type=string) of the server to whom the request is directed

userDn refers to the person (data type=string) making the request

mailboxDn refers to the mailbox (data type=string) which is to be opened

cultureInfo refers to the language in which the content is to appear (one of a collection of languages of data type CultureInfo)

userName refers to the user logon name used for authentication (data type=string) which is to be opened

domainName refers to the portion of address relating to an organization, type or country (data type=string)

password refers to a user password used for logon (data type=string)

userName, domainName and password are used for authentication. userName, domainName and password are used to establish a first RPC connection with the mail server. A second RPC connection may be established to actually perform the access operation.

connectFlags refers to flags that change the behavior of a session after it is opened (e.g., UseTransportPrivilege indicates that the caller is the Transport service) and is one of collection of flags of type ConnectFlag)

storeFlags refers to (one of collection of flags, of type OpenStoreFlag)

windowsIdentity: Once a user is authenticated to the mail server, the user receives a token. This token cannot be used to authenticate to another server but information can be extracted from the token which can be used to get additional information such as what groups a user belongs to, what permissions the user has, and so on. This information when serialized and passed to the backend can be used to determine the identity of the user and to determine access privileges. This information is used when performing the access operation.

The method signature:

internal static MapiStore OpenMailbox(
string serverDn, string userDn, string mailboxDn);

has input parameters serverDn, userDn and mailboxDn and returns the specified opened mailbox on the server identified by the input parameter serverDn made in a request made by user userDn to open mailbox mailboxDn. If the mailbox is not on serverDn, the request is automatically redirected to the correct server and the specified mailbox on the correct server is opened.

The method signature:

```
internal static MapiStore OpenMailbox(
    string serverDn, string userDn, string mailboxDn, CultureInfo
    cultureInfo);
```

has input parameters serverDn, userDn and mailboxDn and returns the specified opened mailbox on the server identified by the input parameter serverDn made in a request made by user userDn to open mailbox mailboxDn. The content is returned in the language specified in cultureInfo. If the mailbox is not on serverDn, the request is automatically redirected to the correct server and the specified mailbox on the correct server is opened.

Others signatures which operate in an analogous fashion include:

```
internal static MapiStore OpenMailbox(
  string serverDn, string userDn, string mailboxDn, string userName,
  string domainName, string password);
internal static MapiStore OpenMailbox(
  string serverDn, string userDn, string mailboxDn, string userName,
  string domainName, string password, CultureInfo cultureInfo);
internal static MapiStore OpenMailbox(
  string serverDn, string userDn, string mailboxDn, string userName,
  string domainName, string password, ConnectFlag connectFlags,
  OpenStoreFlag storeFlags);
internal static MapiStore OpenMailbox(
  string serverDn, string userDn, string mailboxDn,string userName,
  string domainName, string password,ConnectFlag connectFlags,
  OpenStoreFlag storeFlags, WindowsIdentity windowsIdentity);
internal static MapiStore OpenMailbox(
  string serverDn, string userDn, string mailboxDn,
  string userName, string domainName, string password,
  ConnectFlag connectFlags, OpenStoreFlag storeFlags,
  ClientIdentityInfo clientIdentity);
internal static MapiStore OpenMailbox(
  string serverDn, string userDn, string mailboxDn,
  string userName, string domainName, string password,
  ConnectFlag connectFlags, OpenStoreFlag storeFlags,
  ClientIdentityInfo clientIdentity, CultureInfo cultureInfo);
internal static MapiStore OpenMailbox(
  string serverDn, string userDn, string mailboxDn,
  string userName, string domainName, string password,
  ConnectFlag connectFlags, OpenStoreFlag storeFlags,
  ClientIdentityInfo clientIdentity, CultureInfo cultureInfo, string
  applicationId);
internal static MapiStore OpenMailbox(
  string serverDn, string userDn, string mailboxDn, string userName,
  string domainName, string password, ConnectFlag connectFlags,
  OpenStoreFlag storeFlags, CultureInfo cultureInfo);
internal static MapiStore OpenMailbox(
  string serverDn, string userDn, Guid guidMailbox, Guid guidMdb,string
  userName, string domainName, string password,ConnectFlag
  connectFlags, OpenStoreFlag storeFlags,CultureInfo cultureInfo,
  WindowsIdentity windowsIdentity );
internal static MapiStore OpenMailbox(
  string serverDn, string userDn, Guid guidMailbox, Guid guidMdb,
  string userName, string domainName, string password, ConnectFlag
  connectFlags, OpenStoreFlag storeFlags, CultureInfo cultureInfo,
  WindowsIdentity windowsIdentity,string applicationId);
internal static MapiStore OpenMailbox(
  string serverDn, string userDn, string mailboxDn, string userName,
  string domainName, string password,ConnectFlag connectFlags,
  OpenStoreFlag storeFlags,CultureInfo cultureInfo, WindowsIdentity
  windowsIdentity );
internal static MapiStore OpenMailbox(
  string serverDn, string userDn, string mailboxDn,
  string userName, string domainName, string password,
  ConnectFlag connectFlags, OpenStoreFlag storeFlags,
  CultureInfo cultureInfo, WindowsIdentity windowsIdentity,string
  applicationId);
internal static MapiStore OpenMailbox(
  string serverDn, string userDn, string mailboxDn,
  string userName, string domainName, string password, string
  httpProxyServerName,ConnectFlag connectFlags, OpenStoreFlag
  storeFlags,CultureInfo cultureInfo, WindowsIdentity windowsIdentity,
  string applicationId);
```

The OpenMailboxNoRedirect method 208b in some embodiments of the invention is associated with the super class, MapiStore:MapiProp and is used to open a mailbox for subsequent reading or writing of messages in the opened mailbox. If the mailbox being opened is on a different server than the one receiving the method call, this method returns a null object instead of the mailbox contents and returns the identity of the server that hosts the requested mailbox (correctServerDN). This method is used when a process requests a mailbox but should not be permitted to open the mailbox if it does not exist on the specified server. Possible reasons that an open mailbox request to a server not hosting the mailbox should not be honored include but are not limited to the following: a content indexing application attempts to index content on a server to which it does not belong as may happen when a indexer attempts to modify an index for a mailbox that has been moved to another server, or when automatic redirection would not be performant. One or more of the following 10 overloaded method signatures may be used to operate on the mailbox on the backend server 206. Each of these signatures correspond with a set of input parameters comprising some combination of the following pieces of information:

server Dn refers to the name (data type=string) of the server receiving the request

userDn refers to the person (data type=string) making the request

mailboxDn refers to the mailbox (data type=string) which is to be opened

cultureInfo refers to the language in which the content is to appear (one of collection of languages, type CultureInfo)

userName refers to the user logon name used for authentication (data type=string) which is to be opened

domainName refers to the portion of address relating to an organization, type or country (data type=string)

password refers to a user password used for logon (data type=string)

userName, domainName and password are used for authentication. userName, domainName and password are used to establish a first RPC connection with the mail server. A second RPC connection may be established to actually perform the access operation.

connectFlags refers to flags that change the behavior of a session after it is opened (e.g., UseTransportPrivilege indicates that the caller is the Transport service) and is one of collection of flags of type ConnectFlag)

storeFlags refers to (one of collection of flags, of type OpenStoreFlag)

windowsIdentity: Once a user is authenticated to the mail server, the user receives a token. This token cannot be used to authenticate to another server but information can be extracted from the token which can be used to get additional information such as what groups a user belongs to, what permissions the user has, and so on. This information when serialized and passed to the backend can be used to determine the identity of the user and to determine access privileges. This information is used when performing the access operation.

guidMailbox refers to a global unique identifier by which the mailbox is identified

guidMdb refers to a global unique identifier by which the database in which the mailbox or public store is held is identified

applicationId identifies the application that accessed the MAPI.NET API and is used for accounting and debugging purposes

clientIdentity

Method signatures include the following and operate as described above. For example, OpenMailboxNoDirect has input parameters serverDn, userDn and mailboxDn, userName, domainName, password, connectFlags, storeFlags, cultureInfo and returns the identify of the server hosting the specified mailbox if the server identified by the input parameter serverDn made in the request made by user userDn to open mailbox mailboxDn does not host mailboxDn. That is, if the mailbox specified in the open request is not on serverDn, the request is not automatically redirected to the correct server and the specified mailbox is not opened.

```
internal static MapiStore OpenMailboxNoRedirect(
    string serverDn, string userDn, string mailboxDn,
    string userName, string domainName, string password,
    ConnectFlag connectFlags, OpenStoreFlag storeFlags,
    CultureInfo cultureInfo,out string correctServerDN);
internal static MapiStore OpenMailboxNoRedirect(
    string serverDn, string userDn, Guid guidMailbox, Guid guidMdb,
    string userName, string domainName, string password,
    ConnectFlag connectFlags, OpenStoreFlag storeFlags,
    CultureInfo cultureInfo,
    out string correctServerDN);
internal static MapiStore OpenMailboxNoRedirect(
    string serverDn, string userDn, string mailboxDn,
    string userName, string domainName, string password,
    ConnectFlag connectFlags, OpenStoreFlag storeFlags,
    CultureInfo cultureInfo,
    out string correctServerDN, WindowsIdentity windowsIdentity);
internal static MapiStore OpenMailboxNoRedirect(
    string serverDn, string userDn, string mailboxDn,
    string userName, string domainName, string password,
    ConnectFlag connectFlags, OpenStoreFlag storeFlags,
    CultureInfo cultureInfo,
    out string correctServerDN, WindowsIdentity windowsIdentity,
    string applicationId);
internal static MapiStore OpenMailboxNoRedirect(
    string serverDn, string userDn, Guid guidMailbox, Guid guidMdb,
    string userName, string domainName, string password,
    ConnectFlag connectFlags, OpenStoreFlag storeFlags,
    CultureInfo cultureInfo,
    out string correctServerDN, WindowsIdentity windowsIdentity);
internal static MapiStore OpenMailboxNoRedirect(
    string serverDn, string userDn, Guid guidMailbox, Guid guidMdb,
    string userName, string domainName, string password,
    ConnectFlag connectFlags, OpenStoreFlag storeFlags,
    CultureInfo cultureInfo,
    out string correctServerDN, WindowsIdentity windowsIdentity,
    string applicationId);
internal static MapiStore OpenMailboxNoRedirect(
    string serverDn, string userDn, string mailboxDn,
    string userName, string domainName, string password,
    ConnectFlag connectFlags, OpenStoreFlag storeFlags,
    CultureInfo cultureInfo,
    out string correctServerDN, ClientIdentityInfo clientIdentity);
internal static MapiStore OpenMailboxNoRedirect(
    string serverDn, string userDn, string mailboxDn,
    string userName, string domainName, string password,
    ConnectFlag connectFlags, OpenStoreFlag storeFlags,
    CultureInfo cultureInfo,
    out string correctServerDN, ClientIdentityInfo clientIdentity,
    string applicationId);
internal static MapiStore OpenMailboxNoRedirect(
    string serverDn, string userDn, Guid guidMailbox, Guid guidMdb,
    string userName, string domainName, string password,
    ConnectFlag connectFlags, OpenStoreFlag storeFlags,
    CultureInfo cultureInfo,
    out string correctServerDN, ClientIdentityInfo clientIdentity);
internal static MapiStore OpenMailboxNoRedirect(
    string serverDn, string userDn, Guid guidMailbox, Guid guidMdb,
    string userName, string domainName, string password,
    ConnectFlag connectFlags, OpenStoreFlag storeFlags,
    CultureInfo cultureInfo,
    out string correctServerDN, ClientIdentityInfo clientIdentity,string
    applicationId);
```

The OpenPublicStore method 208c in some embodiments of the invention is associated with the class, MapiStore:MapiProp and is used to open a public store for subsequent reading or writing of messages and folders in the opened public store. A public store includes files and directories (folders) which are shared by all or by groups within an organization. (An intuitive non-limiting example of information that might be shared among all people in an organization might be a list of paid holidays.) If the public store being opened is on a different server than the one receiving the method call, this method automatically re-directs the call to the correct server. One or more of the following 10 overloaded method signatures may be used to operate on the public store on the backend server 206. Each of these signatures correspond with a set of input parameters comprising some combination of the following pieces of information:

server Dn refers to the name (data type=string) of the server receiving the request; this name may be the legacy name by which the server was known in previous releases of the mail messaging software or the Active Directory server name

userDn refers to the person (data type=string) making the request, legacy name assigned to the user object in the Active Directory (described below)

mailboxDn refers to the mailbox (data type=string) which is to be opened, a user may open someone else's mailbox

cultureInfo refers to the language in which the content is to appear in this session (one of collection of languages, type CultureInfo)

userName refers to the user logon name used for authentication (data type=string) which is to be opened (account credentials)

domainName refers to the portion of address relating to an organization, type or country (data type=string) (account credentials)

password refers to a user password used for logon (data type=string) (account credentials)

userName, domainName and password are used for authentication. userName, domainName and password are used to establish a first RPC connection with the mail server. A second RPC connection may be established to actually perform the access operation.

connectFlags refers to flags that change the behavior of a session after it is opened (e.g., transport receives info from when connects to be, needs special fx on backend, content indexing, specific to implementation of exchange 2007 (one of collection of flags of type ConnectFlag)

storeFlags refers to (one of collection of flags, of type OpenStoreFlag)

windowsIdentity once a user is authenticated to the mail server, the user receives a token, this token cannot be used to authenticate to another server but information can be extracted from the token which can be used to get additional information such as what groups a user belongs to, what permissions the user has, and so on. This information when serialized and passed to the backend can be used to determine the identity of the user and to determine access privileges. The identity is used to perform the access operation.

applicationId refers to a string that the frontend can pass to the backend for debugging and accounting purposes that identifies the application that received the access request

guidMailbox of type global unique identifier (Guid). One of the attributes of the user object in the Active Directory is the guidMailbox so the mailbox can be opened based on the mailboxDn or by the guidMailbox.

guidMdb every mailbox server can have multiple mailbox databases, so this says open this messaging database

httpProxyServerName used in the conversion of an RTP to go through an HTTP proxy server (allows administrator to monitor availability of mailbox accessed through a proxy server)

Signatures for this method include the following which operate in a fashion analogous to those described above:

```
internal static MapiStore OpenPublicStore(string serverDn,
    string userDn);
internal static MapiStore OpenPublicStore(string serverDn,
    string userDn,CultureInfo cultureInfo);
internal static MapiStore OpenPublicStore(string serverDn,
    string userDn,string userName, string domainName, string password);
internal static MapiStore OpenPublicStore(string serverDn,
    string userDn,
    string userName, string domainName, string password,
    CultureInfo cultureInfo);
internal static MapiStore OpenPublicStore(string serverDn,
    string userDn,
    string userName, string domainName, string password,
    ConnectFlag connectFlags, OpenStoreFlag storeFlags);
internal static MapiStore OpenPublicStore(string serverDn,
    string userDn,
    string userName, string domainName, string password,
    ConnectFlag connectFlags, OpenStoreFlag storeFlags,
    WindowsIdentity windowsIdentity);
internal static MapiStore OpenPublicStore(string serverDn,
    string userDn,
    string userName, string domainName, string password,
    ConnectFlag connectFlags, OpenStoreFlag storeFlags,
    CultureInfo cultureInfo);
internal static MapiStore OpenPublicStore(string serverDn,
    string userDn,
    string userName, string domainName, string password, string
    httpProxyServerName,
    ConnectFlag connectFlags, OpenStoreFlag storeFlags,
    CultureInfo cultureInfo);
internal static MapiStore OpenPublicStore(string serverDn,
    string userDn,
    string userName, string domainName, string password,
    ConnectFlag connectFlags, OpenStoreFlag storeFlags,
    CultureInfo cultureInfo, WindowsIdentity
    windowsIdentity);
internal static MapiStore OpenPublicStore(string serverDn,
    string userDn,
    string userName, string domainName, string password,
    ConnectFlag connectFlags, OpenStoreFlag storeFlags,
    CultureInfo cultureInfo, WindowsIdentity
    windowsIdentity, string applicationId);
```

The OpenPublicStoreNoRedirect method 208d in some embodiments of the invention is associated with the super class, MapiStore:MapiProp and is used to open a public store for subsequent reading or writing of messages and folders in the opened public store. If the public store being opened is on a different server than the one receiving the method call, this method returns a null object instead of the public store contents and the identity of the server that hosts the requested public store (correctServerDN). One or more of the following 4 overloaded method signatures may be used to operate on the public store on the backend server 206. Each of these signatures correspond with a set of input parameters comprising some combination of the following pieces of information:

```
internal static MapiStore OpenPublicStoreNoRedirect(string
    serverDn, string userDn,
    string userName, string domainName, string password,
    ConnectFlag connectFlags, OpenStoreFlag storeFlags,
    out string correctServerDN, WindowsIdentity
    windowsIdentity);
internal static MapiStore OpenPublicStoreNoRedirect(string
    serverDn, string userDn,
    string userName, string domainName, string password,
    string httpProxyServerName,
    ConnectFlag connectFlags, OpenStoreFlag storeFlags,
    out string correctServerDN, WindowsIdentity
    windowsIdentity);
internal static MapiStore OpenPublicStoreNoRedirect(string
    serverDn, string userDn,
    string userName, string domainName, string password,
    ConnectFlag connectFlags, OpenStoreFlag storeFlags,
    CultureInfo cultureInfo,
    out string correctServerDN, WindowsIdentity
    windowsIdentity);
internal static MapiStore OpenPublicStoreNoRedirect(string
    serverDn, string userDn,
    string userName, string domainName, string password,
    ConnectFlag connectFlags, OpenStoreFlag storeFlags,
    CultureInfo cultureInfo,
    out string correctServerDN, WindowsIdentity
    windowsIdentity, string applicationId);
```

The GetContentsTable method 208e in some embodiments of the invention is associated with the super class, MapiContainer:MapiProp and is used to open and return a Table of Contents of items in a folder of a mailbox or public store once the container object has been opened. Input parameters include flags which affect the behavior (views) of the table identified my MapiTable
internal MapiTable GetContentsTable(ContentsTableFlags flags);
internal MapiTable GetContentsTable ( );

The OpenEntry method 208f in some embodiments of the invention is associated with the super class, MapiContainer:MapiProp and is used to open a single item (message) or a single folder inside a mailbox or public folder and provides the contents of the message. Input parameters include:

flags which affect the behavior (views) of the table identified my MapiTable

internal object OpenEntry (byte[ ] entryId);

internal unsafe object OpenEntry (byte[ ] entryId,

The input parameters described above may be related to how the server was configured and to entries made in the Active Directory for that server. An Active Directory stores information and settings relating to an organization in a central, organized, accessible database. store information about the network resources across a domain. Microsoft's Active Directory is a hierarchical framework of objects including resources (like printers), services (like an email service), and users (accounts, or users and groups). The Active Directory provides information on the objects, organizes the objects, controls access, and sets security. Each object within the Active Directory represents an entity and its attributes. An object an also be a container of other objects. A schema defines an object's set of attributes and the kind of objects that can be stored in the Active Directory.

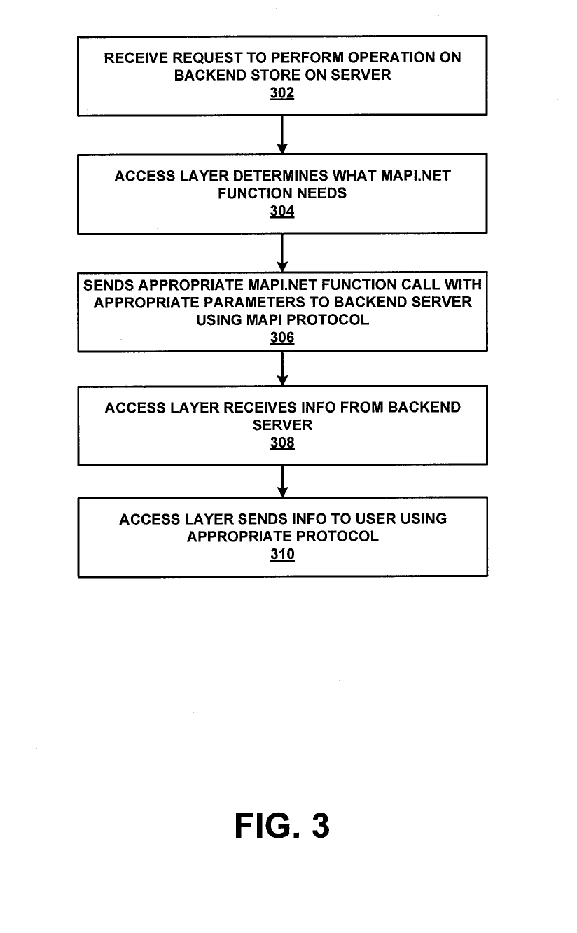

FIG. 3 is a flow diagram for accessing backend server data according to some embodiments of the invention. At 302 a request to perform an operation on a data store located on a backend server is received. The request may be received from a regular POTS telephone, mobile telephone, PDA (personal digital assistant), smart-phone, computer, etc. and may be received by a front-end application of an access layer written in managed code, such as described with respect to FIG. 2.

At 304 the access layer determines from the request what MAPI.NET function is needed and at 306 sends the appropriate MAPTI.NET function call with the appropriate input parameters for the function call gleaned from the initial request to the backend server. Execution of the function results in the issuance of an RPC call in native code to the backend server.

At 308, the backend server returns information to the access layer which sends the information on to the requester using the appropriate protocol for that user request (310).

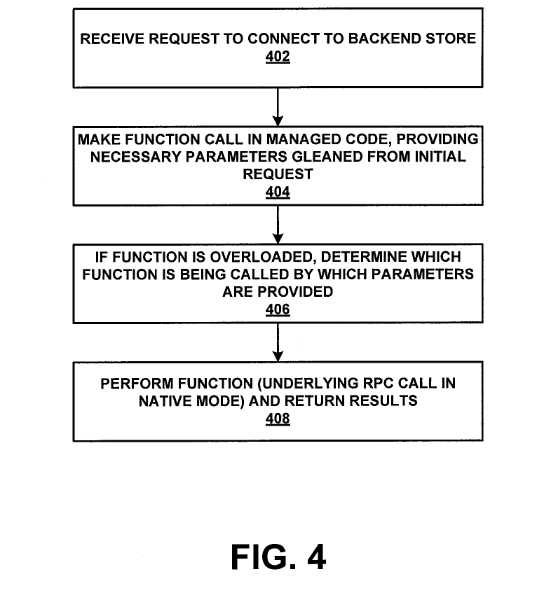

FIG. 4 is another flow diagram for accessing backend server data according to some embodiments of the invention. At 402, a request is received to connect to a data store on a backend server. The request may be received from a regular POTS telephone, mobile telephone, PDA (personal digital assistant), smart-phone, computer, etc. and may be received by a front-end application of an access layer written in managed code, such as described with respect to FIG. 2. At 404, a managed code function call is made, wherein the input parameters for the function call are gleaned from the request. If the function is overloaded, the correct signature to be used to satisfy the request is determined by examining the provided parameters (406). At 408 the function is performed and the results are returned to the requester via the access layer.

The various techniques described herein may be implemented in connection with hardware or software or, where appropriate, with a combination of both. Thus, the methods and apparatus of embodiments of the invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects of embodiments of the invention, e.g., through the use of a data processing API or the like, may be implemented in a high level procedural or object oriented programming language to communicate with a computer system. However, the program(s) can be implemented in assembly or machine language, if desired. In any case, the language may be a compiled or interpreted language, and combined with hardware implementations.

While embodiments of the invention have been described in connection with the figures, it is to be understood that other similar embodiments may be used or modifications and additions may be made to the described embodiments for performing the same functions without deviating therefrom. Therefore, the invention should not be limited to any single embodiment, but rather should be construed in breadth and scope in accordance with the appended claims.

What is claimed:

1. A method of data access comprising:
receiving a request from a client application at a front-end server for access to a specified data store on a backend server, wherein an access layer on the front-end server selects a function of an applications programming interface written in managed code that uses a unified messaging technology comprising MAPI and provides input parameters taken from the received request to the selected function, wherein the selected function issues an RPC call accessing the specified data store on the backend server.

2. The method of claim 1, wherein the backend server and the front-end server are electronic mail servers.

3. The method of claim 1, wherein the specified data store is a mailbox.

4. The method of claim 1, wherein the specified data store is a public folder.

5. The method of claim 1, wherein the input parameters identify at least one of a user, a mailbox, a backend server, authentication information, an identity of an application on the client sending the request to the front-end server, token information, a language in which the data is to be returned or a data store identified by a unique identifier.

6. The method of claim 1, wherein the application programming interface generates a data access request using a unified Messaging Application Programming Interface (MAPI).

7. The method of claim 1, wherein the selected function returns the specified data store, opened.

8. The method of claim 1, wherein the selected function returns an identifier of a server hosting the specified data store.

9. A system for generating an RPC call from a front-end server to a data store hosted on a backend server comprising:
a front-end applications access layer of a front-end mail server that receives a data access request specifying an operation to be performed on a backend data store from a client application, wherein the front-end applications are written in managed code, and wherein the front-end server access layer receives the data access request, selects a function of an applications programming interface written in managed code to interface with the managed code of the front-end applications, wherein the selected function generates a data access request to perform the specified operation on the backend data store and returns one of the backend data store or an identifier of a server that hosts the backend data store.

10. The system of claim 9, wherein the client application comprises a browser, a software client, a mobile device client or an email client.

11. The system of claim 9, wherein the specified operation comprises one of an open mailbox request, an open public store request, a get contents request and an open entry request.

12. The system of claim 11, wherein the data store comprises a mailbox or a public store.

13. The system of claim 11, wherein an open data store request is automatically redirected from a first server to a second server if the second server hosts the specified data store.

14. The system of claim 11, wherein an open data store request received at a first server returns an identifier of a second server when the second server hosts the specified data store.

15. A tangible computer-readable medium comprising computer-executable instructions that when executed cause a computer environment to:
receive a request from a client to access a backend data store at an access layer of a mail server;
select, based on information taken from the request, one of a plurality of function calls to an applications programming interface in managed code to access the backend data store; and
supply a set of input parameters to the selected function call.

16. The computer-readable medium of claim 15, comprising further instructions to:
issue the selected function call with the supplied set of input parameters;
in response to issuing the selected function call, performing the access request and returning a result to the access layer.

17. The computer-readable medium of claim 16, comprising further instructions to:
return an open mailbox or public store wherein the mailbox or public store is located on a server specified in the request.

18. The computer-readable medium of claim 16, comprising further instructions to:
return an open mailbox or public store wherein the mailbox or public store is located on a server not specified in the request or return an identifier of the server on which the mailbox or public store is located.

19. The computer-readable medium of claim 16, comprising further instructions to:
return a list of entries in the data store.

20. The computer-readable medium of claim 16, comprising further instructions to:
return an open entry in the data store.
